(19) United States
(12) Patent Application Publication
(10) Pub. No.: US 2009/0115894 A1
(43) Pub. Date: May 7, 2009

(54) VIDEO PLAYBACK CONTROL METHOD AND BLACK BAR ELIMINATION MODULE USED IN A VIDEO PLAYBACK DEVICE

(76) Inventors: Tzung-I Lin, Xindian city (TW); Chia-Yin Lu, Xindian city (TW)

Correspondence Address: Muncy, Geissler, Olds & Lowe, PLLC, P.O. BOX 1364, FAIRFAX, VA, 22038-1364, US

(21) Appl. No.: 12/195,044

(22) Filed: Aug. 20, 2008

(30) Foreign Application Priority Data
Nov. 5, 2007 (TW) 096141624

(51) Int. Cl. H04N 7/01

(52) U.S. Cl. 348/445; 348/E07.001

(57) ABSTRACT

A video playback control method adapted for a video playback device including the following steps. First, at least one source frame is fetched, with the source frame being corresponding to the video content that is to be displayed on the video playback device. Next, a first aspect ratio of the source frame is compared with a second aspect ratio of the video playback device, and the source frame is directly displayed on the video playback device when the first aspect ratio is the same as the second aspect ratio. Also, when the first aspect ratio is different to the second aspect ratio, the periphery of the source frame is overscanned.

### CROSS REFERENCE TO RELATED APPLICATION

This application claims priority of application No. 096141624 filed in Taiwan R.O.C on Nov. 5, 2007 under 35 U.S.C. §119; the entire contents of which are hereby incorporated by reference.

### FIELD OF THE INVENTION

The invention relates to a video playback control method, particularly to a video playback control method capable of eliminating black bars and a black bar elimination module used in a video playback device.

### DESCRIPTION OF THE RELATED ART

Conventionally, a video playback device often has a preset aspect ratio. When the aspect ratio of a source video frame to be displayed and the aspect ratio of the video playback device are different, black bars are added to the top and bottom, or left and right sides of each frame displayed on the video playback device to maintain the original aspect ratio of the source video frame and completely show the video content as a result.

Currently, a film is often produced conforming to an aspect ratio of 16:9 or 2.35:1. The aspect ratio of 16:9 is a widescreen standard aspect ratio, and the aspect ration of 2.35:1 is an anamorphic standard aspect ratio. Taking a common home-theater projector as an example, its preset aspect ratio is 16:9. Hence, in case a movie having an aspect ratio of 16:9 shown in FIG. 1A is displayed on the home-theater projector, the audience sees the movie where no black bar is added under a full-screen mode, as shown in FIG. 1B. However, in case a movie having an aspect ratio of 2.35:1 shown in FIG. 2A is displayed on the same home-theater projector, black bars are added to the top and the bottom sides of each frame of the movie to maintain its original aspect ratio, as shown in FIG. 2B. In that case, the effective display areas (effective pixels) at the top and the bottom sides of the video playback device are wasted due to the black bars, and, in case the black bars are not sufficiently dark, the display contrast is also deteriorated. Further, when different movies having their respective aspect ratios are displayed, that the movies are displayed by turns with and without black bars is sure to nag at the audience.

Though the above-mentioned problems may be cured by first anamorphically scaling the picture frame to eliminate the black bars and then recovering it by an anamorphic lens installed on the video playback device, the installation of the anamorphic lens considerably increases the fabrication cost.

### BRIEF SUMMARY OF THE INVENTION

The invention provides a video playback control method capable of eliminating black bars and a black bar elimination module used in a video playback device.

According to an embodiment of the invention, a video playback control method adapted for a video playback device includes the following steps. First, at least one source frame is fetched, with the source frame being corresponding to the video content that is to be displayed on the video playback device. Next, a first aspect ratio of the source frame is compared with a second aspect ratio of the video playback device, and the source frame is directly displayed on the video playback device when the first aspect ratio is the same as the second aspect ratio. Also, when the first aspect ratio is different to the second aspect ratio, the periphery of the source frame is overscanned.

In one embodiment, the periphery of the source frame is overscanned at a region outside an action safe area and a title safe area, and the overscan step includes detecting whether the first aspect ratio is larger or smaller than the second aspect ratio. When the first aspect ratio is smaller than the second aspect ratio, the top side and the opposite bottom side of the source frame is overscanned. When the first aspect ratio is larger than the second aspect ratio, the source frame is enlarged according to a scale factor and the left side and the opposite right side of the enlarged source frame is overscanned.

In one embodiment, the first aspect ratio of the source frame is 16:9, the second aspect ratio of the video playback device is 2:1, and the top side and the bottom side of the source frame are respectively overscanned by about 7% and 3% of the vertical span of the source frame.

In one embodiment, the first aspect ratio of the source frame is 2.35:1, the second aspect ratio of the video playback device is 2:1, the scale factor has a value that is equal to the first aspect ratio divided by the second aspect ratio, and the left side and the right side of the enlarged source frame are each overscanned by about 7.45% of the horizontal span of the enlarged source frame.

In one embodiment, the first aspect ratio of the source frame is 2.35:1, the second aspect ratio of the video playback device is 16:9, the scale factor has a value that is smaller than the first aspect ratio divided by the second aspect ratio, and the left side and the right side of the enlarged source frame are each overscanned by about 7.45% of the horizontal span of the enlarged source frame.

According to another embodiment of the invention, a black bar elimination module used in a video playback device includes a reception unit, an operation processing unit, and a size-adjusting unit. The reception unit is used for acquiring at least one source frame corresponding to the video content that is to be displayed on the video playback device. The operation processing unit is used for comparing a first aspect ratio of the source frame with a second aspect ratio of the video playback device and calculating a scale factor for the source frame when the first aspect ratio is larger than the second aspect ratio. The size-adjusting unit is used for enlarging the source frame according to the scale factor and overscanning the periphery of the enlarged source frame.

In one embodiment, the size-adjusting unit is a scalar chip, and the operation processing unit is a micro controller.

According to the above-mentioned embodiments, the black bar may be completely removed or considerable reduced to improve the visual effect. Also, the scale factor value and the overscan proportion may be varied as long as the key portion of the video content is not affected.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1A shows a source video frame having an aspect ratio of 16:9, and FIG. 1B shows a schematic diagram illustrating the source video frame displayed on a video playback device having an aspect ration of 16:9.

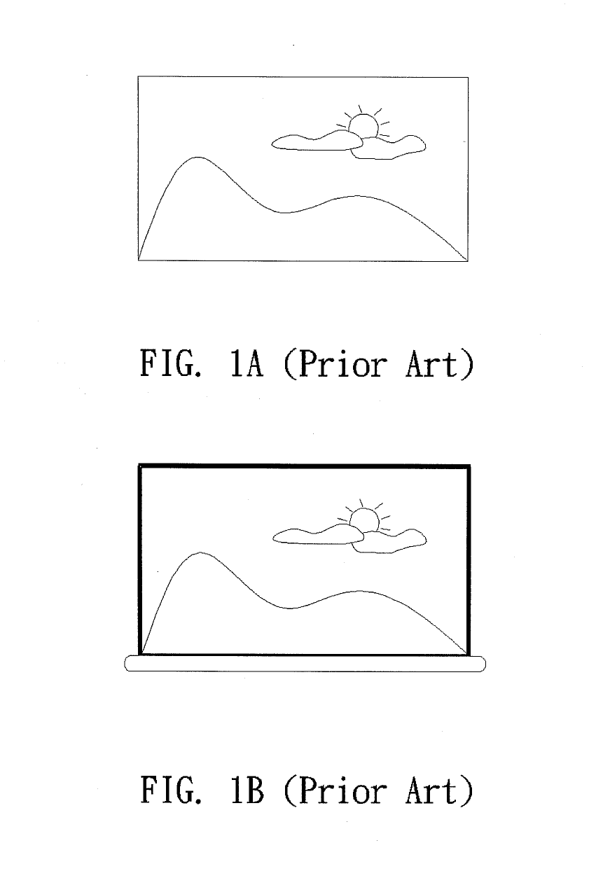

FIG. 2A shows a source video frame having an aspect ratio of 2.35:1, and FIG. 2B shows a schematic diagram illustrating the source video frame displayed on a video playback device having an aspect ration of 16:9.

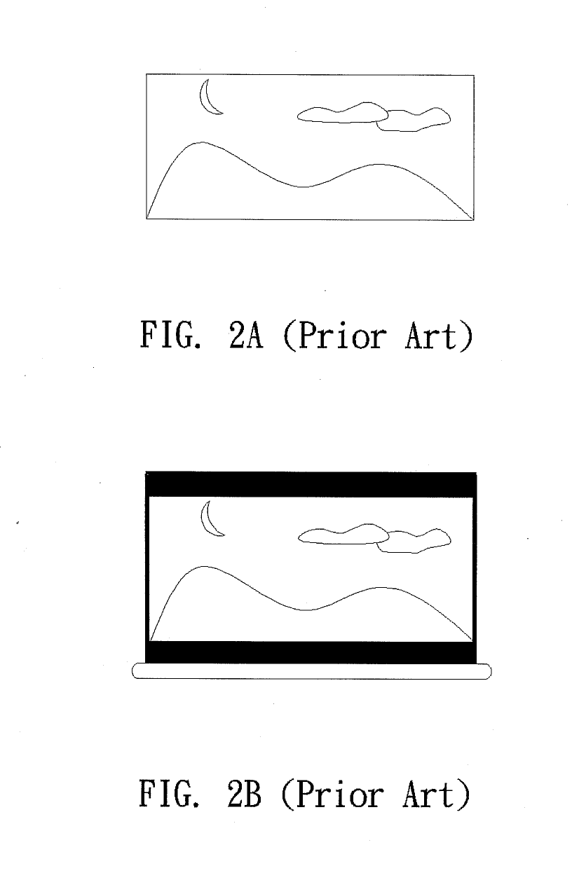

FIG. 3 shows a schematic diagram illustrating the borders of an action safe area and a title safe area defined in the typical film making practice.

FIGS. 4A-4D show schematic diagrams illustrating the treatment for that the aspect ratio of the source frame is 2.35:1 and the video playback device has a preset aspect ratio of 2:1 according to an embodiment of the invention.

FIGS. 5A-5C show schematic diagrams illustrating the treatment for that the aspect ratio of the source frame is 16:9 and the video playback device has a preset aspect ratio of 2:1 according to an embodiment of the invention.

FIGS. 6A-6C show schematic diagrams illustrating the treatment for that the aspect ratio of the source frame is 2.35:1 and the video playback device has a preset aspect ratio of 16:9 according to an embodiment of the invention.

FIG. 7 shows a flow chair illustrating a video playback control method according to an embodiment of the invention.

FIG. 8 shows a schematic diagram illustrating a black bar elimination module used in a video playback device according to an embodiment of the invention.

### DETAILED DESCRIPTION OF THE INVENTION

In the following detailed description of the preferred embodiments, reference is made to the accompanying drawings which form a part hereof, and in which are shown by way of illustration specific embodiments in which the invention may be practiced. In this regard, directional terminology is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” and variations thereof herein are used broadly and encompass direct and indirect connections, couplings, and mountings. Similarly, “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

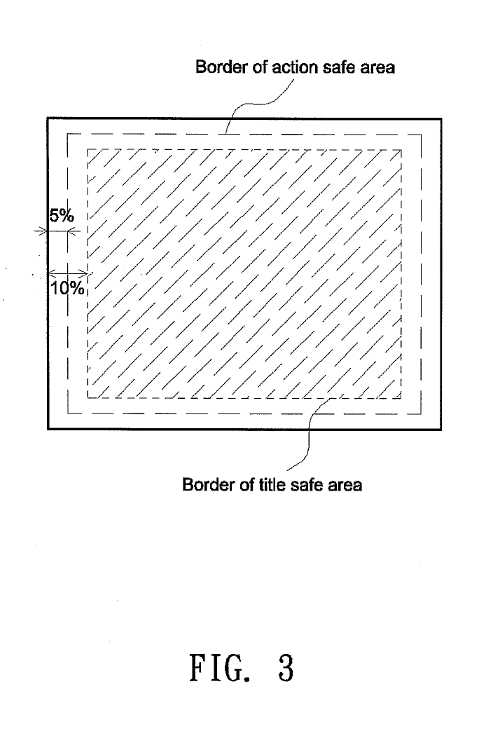

Before each of the embodiments of the invention is set forth below, the overscan treatment and the reservation of safe areas in the process of making films are explained here. For early CRT televisions that fail to perfectly fetch TV signals, an overscan process should be performed to avoid noises appear in the periphery of each displayed frame. However, in order to prevent any key portion of video content from being removed, the overscan process is performed outside an action safe area and a title safe area to ensure key pictures, subtitles or graphics do not exceed the viewing zone of a monitor. Though the overscan process is no longer needed for nowadays video playback device, the film maker is still in the habit of keeping any key portion of video content within the action safe area and the title safe area. For example, as shown in FIG. 3, in a standard film making practice, the action safe area occupies an area that is reduced by 5% per side of a displayed frame, and the title safe area occupies an area that is reduced by 10% per side of the displayed firame. The reduced proportion may be varied according to the selection of a film standard or video playback device. Hence, since the film maker is still in the habit of keeping any key portion of video content within the action safe area and the title safe area, the cut of a small portion in the periphery of a source video frame does not affect the main video content provided for the audience.

Further, the term “aspect ratio” used in the following description and appending claims refers to a common frame ratio known by skilled artisan in the art, and it does not mean a precise value that may limit the invention. More specifically, the skilled artisan may comprehend an aspect ratio of 16:9 (1.78:1) means a typical widescreen aspect ratio but not a rigidly precise value of a displayed width divided by the height. For example, in case the actual measured value of a displayed width divided by the height equals 1.77 or 1.79, it may also be considered as in the scope of the aspect ratio of 16:9.

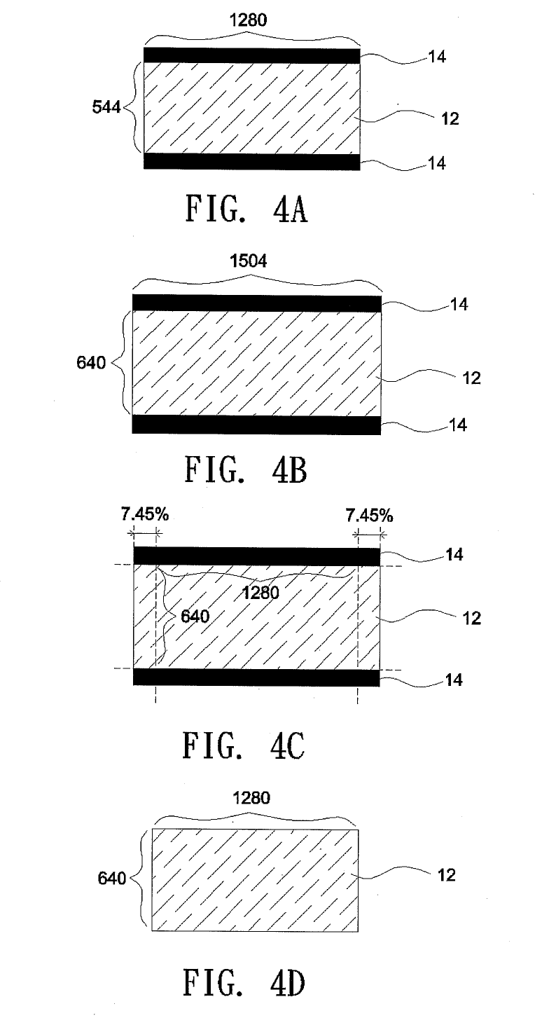

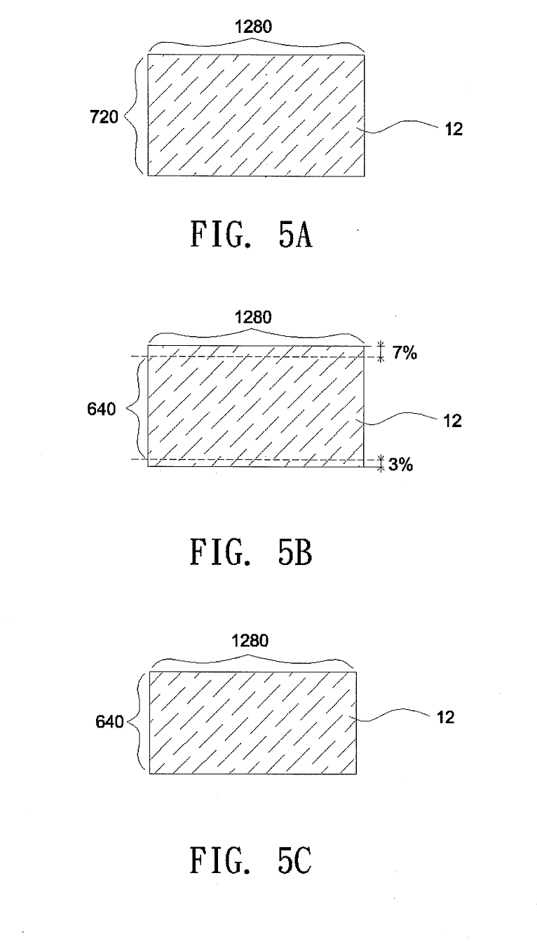

FIGS. 4A-5C show schematic diagrams illustrating an embodiment of a video playback control method according to the invention. In this embodiment, each of the source video frames that is to be displayed by a video playback device (hereinafter briefly referred to as a source frame) has an aspect ratio of 16:9 or 2.35:1, and the video playback device has a preset aspect ratio of 2:1. The aspect ratio of 16:9 is a widescreen standard aspect ratio, and the aspect ratio of 2.35:1 or 2:1 is an anamorphic standard aspect ratio. The video playback device may be a projection display apparatus or a high-definition television (HDTV).

According to this embodiment, first, as the video playback device fetches a source frame, it automatically detects the aspect ratio of the source frame, recognizing whether the aspect ratio is 16:9 or 2.35:1. FIGS. 4A-4D illustrating the treatment for that the aspect ratio of the source frame is recognized as 2.35:1, where the video playback device and the source frame each have 1280 pixels in the horizontal span (a horizontal resolution of 1280).

As shown in FIG. 4A, since the aspect ratio of the source frame 12 is 2.35:1, the number of pixels in the vertical span (hereinafter briefly referred to as the vertical pixel number) of the source frame 12 equals 544(≈1280/2.35). Further, since the video playback device has a preset aspect ratio of 2:1, the vertical pixel number of its displayed frame equals 640 (=1280/2). Hence, since the 544 pixels of the source frame 12 is less than the 640 pixels of the displayed frame (the aspect ratio of the source frame 12 is larger than the preset aspect ratio of the video playback device), the top side and the opposite bottom side of each frame displayed on the video playback device is added with black bars 14. Note the top side and the bottom side are defined according to the viewing direction of the audience. Hence, according to this embodiment, the source frame 12 having an aspect ratio of 2.35:1 is first enlarged, and a preferred scale factor F is defined as the following:

F=(the aspect ratio of the source frame)/(the preset aspect ratio of the video playback device). As a result, a preferred scale factor F equals 1.175 (=2.35/2) in this embodiment. Referring to FIG. 4B, when the source frame 12 is enlarged according to the preferred scale factor F, its vertical pixel number is changed to 640 (≈544×1.175), which is equal to the vertical pixel number of the frame displayed on the video playback device, so the black bar 14 is not needed any longer. However, as the source frame 12 is enlarged, its number of pixels in the horizontal span (hereinafter briefly referred to as the horizontal pixel number) is changed to 1504 (=1280×1.175), which exceeds the 1280 horizontal pixels that the video playback device having an aspect ratio of 2:1 is able to display. In that case, as shown in FIG. 4C, the enlarged source frame 12 is overscanned in its left side and opposite right side, where the left side and the right side are between the top side and the bottom side. In one embodiment, the right side and the left side are overscanned to the same extent. Specially, the right side and the left side of the enlarged source frame 12 are each cut by 112 (=(1504−1280)/2) horizontal pixels, about 7.45%(=112/1504) of the horizontal span of the enlarged source frame 12, so that a source frame 12 having an aspect ratio of 2:1 is obtained as shown in FIG. 4D, and that the black bar 14 is not needed any longer when the source frame 12 is displayed on a video playback device having an aspect ration of 2:1. As described earlier, the film maker is still in the habit of keeping the key portion of video content within the action safe area and the title safe area, and thus, even the right side and the left side are each cut by 7.45% of the horizontal span of the enlarged source frame 12, the key portion of video content is completely not affected.

Next, FIGS. 5A-5C illustrate the treatment for that the aspect ratio of the source frame is recognized as 16:9, where the video playback device and the source frame each have 1280 pixels in the horizontal span (a horizontal resolution of 1280). As shown in FIG. 5A, since the aspect ratio of the source frame 12 is 16:9, the vertical pixel number of the source frame 12 equals 720(=1280÷(16/9)). Further, since the video playback device has a preset aspect ratio of 2:1, the vertical pixel number of the displayed frame equals 640 (=1280/2). Hence, since the 720 pixels of the source frame 12 exceeds the 640 pixels of the displayed frame (the aspect ratio of the source frame12 is smaller than the preset aspect ratio of the video playback device), the top side and the opposite bottom side of the source frame 12 are totally cut by 80 (=720−640) vertical pixels as shown in FIG. 5B, so that a source frame 12 having an aspect ratio of 2:1 shown in FIG. 5C is obtained and displayed on a video playback device having an aspect ration of 2:1.

In one embodiment, the top side and the bottom side are overscanned to different extents, because the subtitles often appear in the bottom side of each video frame. For example, the top side is cut by 7% while the bottom side is cut by 3% of the vertical span of the source frame 12. This may ensure safe display of the subtitles because the bottom side is cut to a lesser extent to provide more spare areas.

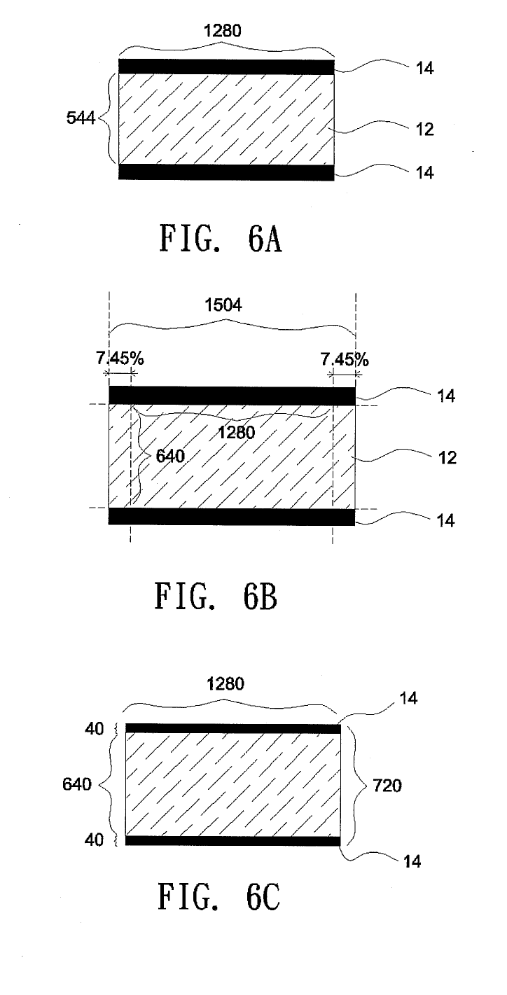

FIGS. 6A-6C show schematic diagrams illustrating another embodiment of the video playback control method. In this embodiment, the source frame has an aspect ratio of 16:9 or 2.35:1, and a video playback device has a preset aspect ratio of 16:9.

According to this embodiment, first, as the video playback device fetches a source frame, it automatically detects the aspect ratio of the source frame, recognizing whether the aspect ratio is 16:9 or 2.35:1. In case the aspect ratio of the source frame is recognized as 16:9, the video playback device directly displays the source frame. In comparison, in case the aspect ratio of the source frame is recognized as 2.35:1, the treatment is illustrated in FIGS. 6A-6C, where the video playback device and the source frame each have 1280 pixels in the horizontal span (a horizontal resolution of 1280).

As shown in FIG. 6A, since the aspect ratio of the source frame 12 is 2.35:1, the vertical pixel number of the source frame 12 equals 544(≈1280/2.35). Further, since the video playback device has a preset aspect ratio of 16:9, the vertical pixel number of its displayed frame equals 720 (=1280÷(16/9)). Hence, since the 544 pixels of the source frame 12 is less than the 720 pixels of the displayed frame (the aspect ratio of the source frame is larger than the preset aspect ratio of the video playback device), the top side and the bottom side of each displayed frame of the video playback device having an aspect ratio of 16:9 are added with black bars 14. Hence, according to this embodiment, the source frame 12 having an aspect ratio 2.35:1 is first enlarged. In case the source frame 12 is enlarged according to a preferred scale factor F of 1.322 (≈2.35÷(16/9)), its vertical pixel number is changed to 720 (≈544×1.322), which is equal to the vertical pixel number of each displayed frame of the video playback device, so the black bar 14 is not needed any longer. However, as the source frame 12 is so enlarged, its horizontal pixel number is changed to 1692 (=1280×1.322), and thus the right side and the left side of the enlarged source frame 12 are each cut by 206 (=(1692−1280)/2) horizontal pixels. This raises the overscan proportion to 12.17%(=206/1692) of the horizontal span of the enlarged source frame 12 and may miss part of the key portion of video content provided for the audience.

Hence, according to this embodiment, a safe overscan proportion of 7.45% is adopted to avoid the miss of the key portion of video content, and as a result a safe scale factor F′ of 1.175 is obtained. When the source frame 12 is enlarged according to the safe scale factor F′ of 1.175, its vertical pixel number is changed to 640 (≈544×1.175). In that case, though the black bar fails to be completely removed, part of it, i.e. 96(640−54) pixels in the vertical span, is cut away to considerably improve the visual effect.

According to the above-mentioned embodiments, it is seen the scale factor F may be determined according to the tolerant extent of overscan. In order to completely remove the black bar, a preferred scale factor F is set to have a value that is equal to the aspect ratio of the source frame divided by the aspect ratio of the video playback device. However, the scale factor may also be set to have a value smaller than the preferred scale factor F to avoid the overscan proportion exceeding the tolerant extent, match with the selection of the video playback device, or take other factor into consideration. In that case, though the black bar fails to be completely removed, a considerable part of it is allowed to be cut away to also improve the visual effect.

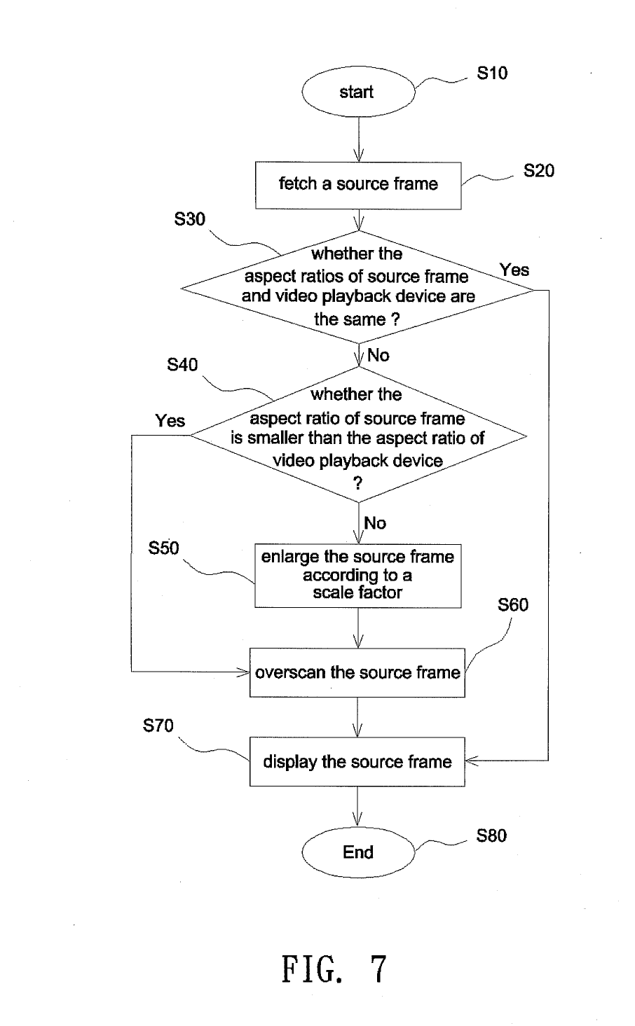

Accompanying with the flow chart shown in FIG. 7, a video playback control method according to an embodiment of the invention is described below. Referring to FIG. 7, the method includes the following steps:
Step S10: Start.
Step S20: Fetch a source frame corresponding to a video content to be displayed by a video playback device.
Step S30: Compare a first aspect ratio of the fetched source frame with a second aspect ratio of the video playback device. If they are different, proceed to the next step S40; if they are the same, skip to Step S70.
Step S40: Detect whether the first aspect ratio of the fetched source frame is smaller than the second aspect ratio of the video playback device. If no, proceed to the next step S50; if yes, skip to Step S60.
Step S50: Enlarge the source frame according to a scale factor.
Step S60: Overscan the source frame.
Step S70: Display the source frame by the video playback device.
Step S80: End.

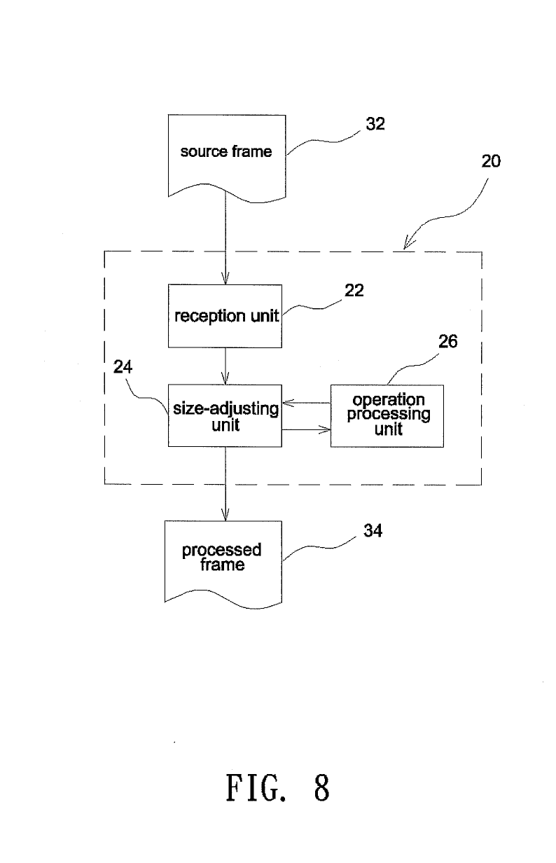

FIG. 8 shows a schematic diagram illustrating a black bar elimination module used in a video playback device. Referring to FIG. 8, the black bar elimination module 20 includes a reception unit 22, a size-adjusting unit 24, and an operation processing unit 26. The reception unit 22 acquires at least one source frame 32 corresponding to a video content, and the size-adjusting unit 24 detects the aspect ratio of the source frame 32. The operation processing unit 26 compares the aspect ratio of the source frame 32 with the preset aspect ratio of the video playback device. When the aspect ratio of the source frame 32 is larger than the preset aspect ratio of the video playback device, the operation processing unit 26 calculates a scale factor for the source frame 32, and then the size-adjusting unit 24 enlarges the source frame 32 according to the scale factor and overscans the periphery of the enlarged source frame 32. After that, the processed frame 34 is output and displayed on the video playback device.

In one embodiment, the size-adjusting unit 24 is a scalar chip, and the operation processing unit 26 is a micro controller.

Note though the preset aspect ratio of the video playback device is exemplified as 16:9 or 2:1 in the above-mentioned embodiments, this not limited. The method described in the above-mentioned embodiments where the source frame is scaled and overscanned to completely eliminate or considerably reduce the black bar is suitable for different video playback devices having their respective aspect ratios.

Further, the aspect ratio of the source frame is not limited; for example, various widescreen standard aspect ratios (such as 16:9, 1.85:1 or 16:10) or anamorphic standard aspect ratios (such as 2.35:1 or 2:1) may be applied in the above-mentioned embodiments where the source frame is scaled and overscanned to completely eliminate or considerably reduce the black bar.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the elements or component is explicitly recited in the following claims.

What is claimed is:

1. A video playback control method adapted for a video playback device, comprising the steps of:
fetching at least one source frame corresponding to a video content that is to be displayed on the video playback device;
comparing a first aspect ratio of the source frame with a second aspect ratio of the video playback device;
directly displaying the source frame on the video playback device when the first aspect ratio is the same as the second aspect ratio; and
overscanning a periphery of the source frame when the first aspect ratio is different to the second aspect ratio.

2. The video playback control method as claimed in claim 1, wherein the overscan steps comprise:
detecting whether the first aspect ratio is larger or smaller than the second aspect ratio;
overscanning a top side and an opposite bottom side of the source frame when the first aspect ratio is smaller than the second aspect ratio; and
enlarging the source frame according to a scale factor and overscanning a left side and an opposite right side of the enlarged source frame when the first aspect ratio is larger than the second aspect ratio, wherein both of the left side and the right side are located between the top side and the bottom side.

3. The video playback control method as claimed in claim 2, wherein the scale factor comprises a value that is equal to the first aspect ratio divided by the second aspect ratio.

4. The video playback control method as claimed in claim 2, wherein the scale factor comprises a value that is smaller than the first aspect ratio divided by the second aspect ratio.

5. The video playback control method as claimed in claim 2, wherein the left side and the right side of the enlarged source frame are each overscanned to the same extent.

6. The video playback control method as claimed in claim 2, wherein the top side of the source frame is overscanned to a large extent compared to the bottom side of the source frame.

7. The video playback control method as claimed in claim 2, wherein the first aspect ratio of the source frame comprises a widescreen standard aspect ratio, and the second aspect ratio of the video playback device comprises an anamorphic standard aspect ratio.

8. The video playback control method as claimed in claim 7, wherein the first aspect ratio of the source frame is 16:9, the second aspect ratio of the video playback device is 2:1, and the top side and the bottom side of the source frame are respectively overscanned by about 7% and 3% of the vertical span of the source frame.

9. The video playback control method as claimed in claim 2, wherein the first aspect ratio of the source frame and the second aspect ratio of the video playback device are each an anamorphic standard aspect ratio.

10. The video playback control method as claimed in claim 9, wherein the first aspect ratio of the source frame is 2.35:1, the second aspect ratio of the video playback device is 2:1, and the left side and the right side of the enlarged source frame are each overscanned by about 7.45% of the horizontal span of the enlarged source frame.

11. The video playback control method as claimed in claim 2, wherein the first aspect ratio of the source frame comprises an anamorphic standard aspect ratio, and the second aspect ratio of the video playback device comprises a widescreen standard aspect ratio.

12. The video playback control method as claimed in claim 1, wherein the first aspect ratio of the source frame is 2.35:1, the second aspect ratio of the video playback device is 16:9, and the left side and the right side of the enlarged source frame are each overscanned by about 7.45% of the horizontal span of the enlarged source frame.

13. The video playback control method as claimed in claim 1, wherein the periphery of the source frame is overscanned at a region outside an action safe area and a title safe area.

14. A video playback control method, comprising the steps of:
detecting the aspect ratio of at least one source frame fetched by a video playback device;
enlarging the source frame according to a scale factor when the specific value of the aspect ratio is larger than two; and
overscanning a periphery of the enlarged source frame, wherein the periphery of the enlarged source frame is overscanned at a region outside an action safe area and a title safe area.

15. A black bar elimination module used in a video playback device, comprising:
a reception unit for acquiring at least one source frame corresponding to a video content that is to be displayed on the video playback device;
an operation processing unit for comparing a first aspect ratio of the source frame with a second aspect ratio of the video playback device and calculating a scale factor for the source frame when the first aspect ratio is larger than the second aspect ratio; and
a size-adjusting unit for enlarging the source frame according to the scale factor and overscanning the periphery of the enlarged source frame.

16. The black bar elimination module as claimed in claim 15, wherein the scale factor comprises a value that is equal to the first aspect ratio divided by the second aspect ratio.

17. The black bar elimination module as claimed in claim 15, wherein the scale factor comprises a value that is smaller than the first aspect ratio divided by the second aspect ratio.

18. The black bar elimination module as claimed in claim 15, wherein the periphery of the source frame is overscanned at a region outside an action safe area and a title safe area.

19. The black bar elimination module as claimed in claim 15, wherein the size-adjusting unit comprises a scalar chip.

20. The black bar elimination module as claimed in claim 15, wherein the operation processing unit comprises a micro controller.
